(19) United States
(12) Patent Application Publication
(10) Pub. No.: US 2006/0008694 A1
(43) Pub. Date: Jan. 12, 2006

(54) Stainless steel alloy and bipolar plates

(76) Inventors: Michael K. Budinski, Pittsford, NY (US); Keith E. Newman, Pittsford, NY (US); Gerald W. Fly, Geneseo, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/165,425

(22) Filed: Jun. 23, 2005

Related U.S. Application Data
(60) Provisional application No. 60/582,791, filed on Jun. 25, 2004.

(51) Int. Cl. H01M 8/02; C22C 30/02; C22C 30/00

(52) U.S. Cl. 429/34; 429/210; 420/582; 420/586.1

(57) ABSTRACT

An improved bipolar plate stainless steel alloy comprises, in weight percent, about 20% to about 30% chromium, about 10% to about 25% nickel, about 1% to about 9 % molybdenum, and up to about 4% copper, where the weight percentage of chromium plus nickel plus molybdenum is greater than about 51 percent. The weight percentage of chromium plus molybdenum may be greater than about 1.66 times the weight percentage of nickel. In addition, the ratio of chromium equivalents to nickel equivalents may be greater than about 1.66.

### CROSS-REFERENCE TO RELATED APPLICATIONS

This application claims the benefit of U.S. Provisional Application Ser. No. 60/582,791, filed Jun. 25, 2004.

### BACKGROUND OF THE INVENTION

The present invention relates to stainless steel alloys. More particularly, the present invention relates to stainless steel alloys exhibiting good corrosion resistance, low contact resistance, good formability, and good weldability. Additionally, the present invention relates to bipolar plates made from such alloys.

Electrochemical catalytic reaction cells, such as fuel cells, may employ proton exchange membranes. The proton exchange membranes operate in a very corrosive environment. Additionally, the proton exchange membrane material may be subject to degradation in the presence of iron contamination. This degradation may create an even more corrosive and acidic environment within the fuel cell.

Bipolar plates often separate and connect fuel cells within a fuel cell stack, and the bipolar plates may be made from stainless steel. However, many stainless steel alloys do not exhibit adequate corrosion resistance in the fuel cell environment. Additionally, many stainless steel alloys do not exhibit suitable formability or weldability.

Thus, there remains a need in the art for stainless steel alloys that exhibit corrosion resistance, formability, and weldability. Additionally, there remains a need in the art for bipolar plates made from such alloys.

### BRIEF SUMMARY OF THE INVENTION

According to the present invention, an improved bipolar plate stainless steel alloy is provided. In accordance with one embodiment of the present invention, the stainless steel alloy comprises, in weight percent, about 20% to about 30% chromium, about 10% to about 25% nickel, about 1% to about 9% molybdenum, and up to about 4% copper, where the weight percentage of chromium plus nickel plus molybdenum is greater than about 51 percent.

In accordance with another embodiment of the present invention, the weight percentage of chromium plus molybdenum is greater than about 1.66 times the weight percentage of nickel. In yet another embodiment of the present invention, the ratio of chromium equivalents to nickel equivalents is greater than about 1.66.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 is an illustration of a portion of a device comprising an electrochemical catalytic reaction cell.

FIG. 2 is schematic illustration of a device having a fuel processing system and an electrochemical catalytic reaction cell in accordance with the present invention.

FIG. 3 is a schematic illustration of a vehicle having a fuel processing system and an electrochemical catalytic reaction cell in accordance with the present invention.

### DETAILED DESCRIPTION OF THE PREFERRED EMBODIMENTS

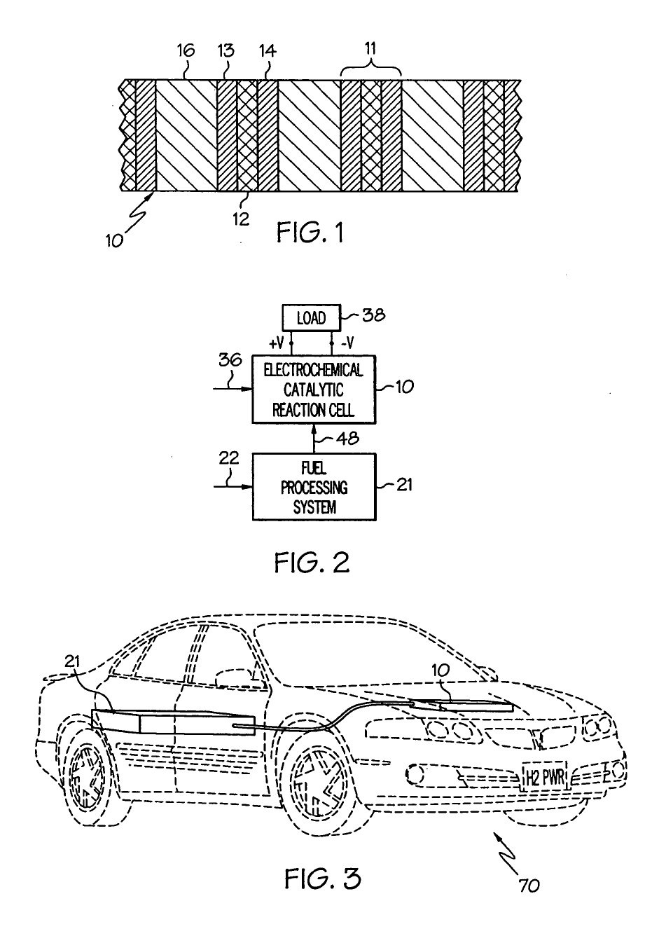

Referring to FIG. 1, a portion of a device 10 comprising an electrochemical catalytic reaction cell is illustrated. The device 10 comprises a plurality of membrane electrode assemblies 11, and each membrane electrode assembly 11 comprises a proton exchange membrane 12, an anode 13, and a cathode 14. A bipolar plate 16 separates the membrane electrode assemblies 11 from one another. Generally, a first reactant is fed into the anode 13 and a second reactant is fed into the cathode 14. Catalytic reactions occur at the anode 13 and the cathode 14 respectively, and protons and electrons are produced. Generally, the protons migrate through the proton exchange membrane 12 and the electrons comprise an electric current that may be used to power a load. For example, the first reactant may be hydrogen gas and the second reactant may be oxygen. Any fuel cell configuration where hydrogen is utilized in the production of electricity is contemplated in the present invention.

The bipolar plates 16 generally separate the anode 13 of one membrane electrode assembly 11 from the cathode 14 of an adjacent membrane electrode assembly 111. The bipolar plates 16 may act as current collectors in the electrochemical catalytic reaction cell 10 and the bipolar plates 16 may have flow channels to direct first and second reactants to a desired location. Any suitable bipolar plate design may be used in the present invention.

The bipolar plate 16 comprises a stainless steel alloy. The stainless steel alloy comprises, in weight percent, about 20% to about 30% chromium, about 10% to about 25% nickel, about 3% to about 9% molybdenum, and 0 to about 4% copper. Additionally, the weight percentage of chromium plus nickel plus molybdenum is greater than about 51 percent. The weight percentage of chromium plus molybdenum is generally greater than about 1.66 times the weight percentage of nickel.

The following table presents a comparison of an alloy composition according to the present invention (see “Target wt. %) and a variety of conventional stainless steel alloy compositions (referred to with reference to their common commercial names or trademarks). It is noted that the alloy composition presented in the table below is presented as an example only and should not be read as a definition or limitation of the range of alloys contemplated by the present invention. Rather, in this regard reference should be made to the scope of the invention defined in the appended claims.

| | | | | | 254 | |
|---|---|---|---|---|---|---|
| Element | Target wt. % | 316L | 317L | 349 | SMO ® | 904L |
| Cr | 20.0-30.0 | 17 | 19 | 23.25 | 20 | 21 |
| Ni | 10.0-25.0 | 12 | 13 | 14.55 | 18 | 25.5 |
| Mo | 3.0-9.0 | 2.5 | 3.5 | 0.2 | 6.25 | 4.5 |
| Cu | 0-4.0 | 0 | 0 | 0.2 | 0.75 | 1.5 |
| Cr + Ni + Mo | >51 | 31.5 | 35.5 | 38 | 44.25 | 51 |
| Cr + Mo | >1.66 * Ni | 19.5 | 22.5 | 23.45 | 26.25 | 25.5 |
| (1.66 × Ni) | | (19.92) | (21.58) | (24.15) | (29.88) | (42.33) |
| Mn | 2 (max.) | 1 | 1 | 1.6 | 0.5 | 1 |
| Si | 1.0-1.5 | 0.5 | 0.5 | 1.5 | 0.4 | 0.5 |
| C | 0.02 (max.) | 0.03 | 0.03 | 0.06 | 0.02 | 0.02 |
| S | 0.001 (max.) | 0.03 | 0.03 | 0.002 | 0.01 | 0.035 |
| N | 0.001 (max.) | 0.08 | 0.08 | 0.165 | 0.22 | 0.08 |
| Nb | 1.0-2.0 | 0 | 0 | 0.4 | 0 | 0 |
| Ti | 0.05 (max.) | 0 | 0 | 0 | 0 | 0 |

The stainless steel alloys of the present invention are generally formulated such that the alloys exhibit good corrosion resistance to solutions comprising dilute sulfuric acid and dilute hydrofluoric acid. For example, the stainless steel alloys of the present invention may be formulated to be resistant to corrosion in solutions having a pH of 3, containing 12.5 ppm H₂SO₄ and 1.8 ppm HF, and being at a temperature of 80° C. and at an i_{corr} of less than 10⁻⁶ A/cm² at −0.4 V_{Ag/AgCl}. It will be understood that i_{corr} refers to the critical electrical current at which corrosion may occur for a given set of conditions. In a further example, the stainless steel alloys of the present invention may be formulated to be resistant to corrosion in solutions having a pH of 3, containing 12.5 ppm H₂SO₄ and 1.8 ppm HF, and being at a temperature of 80° C. and at an i_{corr} of less than 10⁻⁶ A/cm² at 0.6 V_{Ag/AgCl}. The alloys may be formulated to provide bipolar plates 16 having a part life of about 10 years with 6000 hours of life at 80° C.

The alloys generally exhibit weldability. For purposes of defining and describing the present invention, “weldability” shall be understood as referring to materials that are unlikely to exhibit weld metal solidification cracking during welding by, e.g., laser welding, projection weldbonding, etc. The alloys of the present invention generally exhibit formability. For purposes of defining and describing the present invention, “formability” shall be understood as referring to stainless steel alloys exhibiting the ability to be formed into profiled plates by, e.g., stamping 0.1 mm to about 0.15 mm plates via a punch press. For example, a suitable alloy may have a maximum yield strength approaching about 40,000 psi, a maximum tensile strength approaching about 90,000 psi, a minimum percent elongation of about 55% for a 2 inch length article, a strain hardening exponent of about 0.35 in the 0/45/90° directions, a strength coefficient of about 190,000 psi, and minimum planar anisotropy of 0.95 with a Δr up to about negative 0.3.

The alloys generally comprises no greater than about 0.02 weight percent sulfur plus phosphorous. For example, the alloys may comprise no greater than about 0.001% sulfur and no greater than about 0.019% phosphorous. A low phosphorous and sulfur content improves the weldability of the alloys. The alloys generally have a ratio of chromium equivalents to nickel equivalents that is greater than about 1.66. The chromium equivalents of the alloys may be calculated using ferrite stabilizing elements such as chromium, molybdenum, niobium, titanium, silicon, and the like. For example, the chromium equivalents may be calculated in accordance with the following formula:
Chromium equivalents=% Cr+(1.37*% Mo)+(1.5*% Si)+(2*% Nb)+(3*% Ti)

The nickel equivalents of the alloys may be calculated using austenite stabilizing elements such as nickel, manganese, copper, carbon, nitrogen, and the like. For example, the nickel equivalents may be calculated in accordance with the following formula:
Nickel equivalents=% Ni+(0.31*% Mn)+(22*% C)+(14.2*% N)+% Cu
It is contemplated that a chromium equivalents to nickel equivalents ratio of greater than about 1.66 will improve the weldability of the alloys.

The stainless steel alloys of the present invention may further comprise, in weight percent about 1.0% to about 1.5% silicon; about 1.0% to about 2.0% niobium; no greater than about 0.02% carbon; no greater than about 0.05% titanium; no greater than about 0.001% nitrogen; and no greater than about 2.00% manganese. The remainder of the alloys may comprise iron and incidental impurities. For purposes of defining and describing the present invention, “incidental impurities” shall be understood as referring to those impurities that are known to occur during the process of fabricating stainless steel alloys.

Referring to FIG. 2, an exemplary device comprising a fuel processing system 21 and an electrochemical catalytic reaction cell 10 is illustrated. The fuel processing system 21 provides the electrochemical catalytic reaction cell 10 with a source of hydrogen 48. For example, the fuel processing system 21 may process a hydrocarbon fuel stream 22 such that hydrogen gas 48 is produced. The fuel processing system 21 may be any suitable fuel processing system. For example, the fuel processing system 21 may have an autothermal reactor, a water-gas shift reactor, and a final stage scrubber. The hydrogen 48 from the fuel processing system 21 and oxygen from an oxidant stream 36 react in the electrochemical catalytic reaction cell 10 to produce electricity for powering a load 38.

Referring to FIG. 3, the device of the present invention may further comprise a vehicle body 70 and an electrochemical catalytic reaction cell 10. The electrochemical catalytic reaction cell 10 may be configured to at least partially provide the vehicle body 70 with motive power. The vehicle body 100 may also have a fuel processing system 21 to supply the electrochemical catalytic reaction cell 10 with hydrogen. It will be understood by those having skill in the art that the electrochemical catalytic reaction cell 10 and fuel processing system 21 are shown schematically and may be used or placed in any suitable manner within the vehicle body 70.

Unless otherwise indicated, all numbers expressing quantities of ingredients, properties such as tensile strength, and so forth as used in the specification and claims are to be understood as being modified in all instances by the term “about.” Accordingly, unless otherwise indicated, the numerical properties set forth in the preceding specification and following claims are approximations that may vary depending on the desired properties sought to be obtained in embodiments of the present invention.

It will be obvious to those skilled in the art that various changes may be made without departing from the scope of the invention, which is not to be considered limited to what is described in the specification.

1. A device configured to generate an electric current from first and second reactants, wherein:
said device comprises an electrochemical catalytic reaction cell;
said electrochemical catalytic reaction cell comprises at least one bipolar plate;
said bipolar plate comprises a stainless steel alloy;
said stainless steel alloy comprises, in weight percent,
about 20% to about 30% chromium;
about 10% to about 25% nickel;
about 1% to about 9% molybdenum; and
up to about 4% copper;
said weight percentage of chromium plus nickel plus molybdenum is greater than about 51 percent.

2. The device as claimed in claim 1 wherein said stainless steel alloy further comprises no greater than about 0.02 weight percent sulfur plus phosphorous.

3. The device as claimed in claim 1 wherein the weight percentage of chromium plus molybdenum is greater than about 1.66 times the weight percentage of nickel.

4. The device as claimed in claim 1 wherein the ratio of chromium equivalents to nickel equivalents is greater than about 1.66.

5. The device as claimed in claim 1 wherein said stainless steel alloy exhibits corrosion resistance to solutions comprising dilute sulfuric acid and dilute hydrofluoric acid.

6. The device as claimed in claim 1 wherein said stainless steel alloy exhibits formability.

7. The device as claimed in claim 1 wherein said stainless steel alloy exhibits weldability.

8. The device as claimed in claim 1 wherein said stainless steel alloy exhibits corrosion resistance to solutions comprising dilute sulfuric acid and dilute hydrofluoric acid, sheet formability, and weldability.

9. The device as claimed in claim 1 wherein said stainless steel alloy further comprises, in weight percent,
about 1.0% to about 1.5% silicon;
about 1.0% to about 2.0% niobium;
no greater than about 0.02% carbon;
no greater than about 0.001% sulfur;
no greater than about 0.019% phosphorous;
no greater than about 0.05% titanium;
no greater than about 0.001% nitrogen;
no greater than about 2.00% manganese; and
the remainder iron and incidental impurities.

10. The device as claimed in claim 1 wherein said first reactant comprises hydrogen gas, and wherein said second reactant comprises oxygen.

11. The device as claimed in claim 1 wherein said device further comprises a fuel processing system for providing hydrogen gas to said electrochemical catalytic reaction cell.

12. The device as claimed in claim 1 wherein said device further comprises:
a vehicle body, wherein said electrochemical catalytic reaction cell at least partially provides said vehicle body with motive power; and
a fuel processing system for providing said electrochemical catalytic reaction cell with said first reactant, wherein said first reactant comprises hydrogen gas.

13. A stainless steel alloy, consisting essentially of, in weight percent:
about 20% to about 30% chromium;
about 10% to about 25% nickel;
about 3% to about 9% molybdenum, wherein the weight percentage of chromium plus nickel plus molybdenum comprises at least 51%;
0 to about 4% copper;
about 1.0% to about 1.5% silicon;
about 1.0% to about 2.0% niobium;
no greater than about 0.02% carbon;
no greater than about 0.001% sulfur;
no greater than about 0.019% phosphorous;
no greater than about 0.05% titanium;
no greater than about 0.001% nitrogen;
no greater than about 2.00% manganese; and
the remainder iron and incidental impurities.

14. A device configured to generate an electric current from first and second reactants, wherein:
said device comprises an electrochemical catalytic reaction cell;
said electrochemical catalytic reaction cell comprises at least one bipolar plate;
said bipolar plate comprises a stainless steel alloy;
said stainless steel alloy consists essentially of, in weight percent:
about 20% to about 30% chromium;
about 10% to about 25% nickel;
about 3% to about 9% molybdenum, wherein the weight percentage of chromium plus nickel plus molybdenum comprises at least 51%;
0 to about 4% copper;
about 1.0% to about 1.5% silicon;
about 1.0% to about 2.0% niobium;
no greater than about 0.02% carbon;
no greater than about 0.001% sulfur;
no greater than about 0.019% phosphorous;
no greater than about 0.05% titanium;
no greater than about 0.001% nitrogen;
no greater than about 2.00% manganese; and
the remainder iron and incidental impurities;
the weight percentage of chromium plus molybdenum is greater than 1.66 times the weight percentage of nickel in said stainless steel alloy;
the ratio of chromium equivalents to nickel equivalents is greater than about 1.66 in said stainless steel alloy; and
said stainless steel alloy exhibits corrosion resistance to solutions comprising dilute sulfuric acid and dilute hydrofluoric acid.
